(19) United States
(12) Patent Application Publication
(10) Pub. No.: US 2021/0221953 A1
(43) Pub. Date: Jul. 22, 2021

(54) POLYIMIDE OR POLY(AMIDE-IMIDE) FILM, DISPLAY DEVICE INCLUDING SAME, AND METHOD FOR PREPARING SAME

(71) Applicants: SAMSUNG ELECTRONICS CO., LTD., Suwon-si (KR); SAMSUNG SDI CO., LTD., Yongin-si (KR)

(72) Inventors: A Ra JO, Euiwang-si (KR); Chanjae AHN, Suwon-si (KR); Sungwon CHOI, Hwaseong-si (KR); Sun Jin SONG, Seoul (KR); Boreum JEONG, Daejeon (KR); Won Suk CHANG, Hwaseong-si (KR)

(21) Appl. No.: 17/205,637

(22) Filed: Mar. 18, 2021

Related U.S. Application Data
(62) Division of application No. 16/003,651, filed on Jun. 8, 2018.

(30) Foreign Application Priority Data
Jun. 9, 2017 (KR) 10-2017-0072710

(51) Int. Cl. C08G 73/10; C08J 5/18; C09D 179/08; C08G 73/14

(52) U.S. Cl. CPC C08G 73/1067; C08J 5/18; C08G 73/1039; G02F 1/133305; C09D 179/08; C08G 73/14; C08G 73/1042

(57) ABSTRACT

A film comprising a polyimide or poly(imide-amide) copolymer, wherein the film has an amplitude of a surface roughness curve of less than or equal to 270 nanometers.

### CROSS-REFERENCE TO RELATED APPLICATIONS

This application claims priority to Korean Patent Application No. 10-2017-0072710 filed in the Korean Intellectual Property Office on Jun. 9, 2017, and all the benefits accruing therefrom under 35 U.S.C. § 119, the content of which is incorporated herein in its entirety by reference.

### BACKGROUND

### 1. Field

A polyimide or poly(imide-amide) copolymer film, a display device including a polyimide or poly(imide-amide) copolymer film, and a method for fabricating a polyimide or poly(imide-amide) copolymer film are disclosed.

### 2. Description of the Related Art

Portable display devices such as a smart phone or a tablet personal computer (PC) have been objects of active research because of their high performance and popularity. For example, research and development efforts to commercialize a light-weight flexible (i.e., bendable or foldable) portable display device have been undertaken. The portable display device of a liquid crystal display or the like includes a protective window for protecting a display module such as a liquid crystal layer. Currently, most portable display devices include a window including a rigid glass substrate. However, glass is a fragile material, which is easily broken by an exterior impact when used in a portable display device or the like. Also, glass is a non-flexible material, so it may not be suitable for a flexible display device. Therefore, extensive efforts have been undertaken to substitute a protective window with a plastic film in a display device. However, it is very difficult for a plastic film to simultaneously satisfy optimal mechanical properties, such as hardness, and optimal optical properties, which are required for the protective window in a display device. Accordingly, the development of the plastic film material as a protective window for a display device has been delayed.

There still remains a need for polymers having excellent optical and mechanical properties that could be used in transparent plastic films.

### SUMMARY

An embodiment provides a polyimide or poly(imide-amide) copolymer film having reduced mura on its surface.

Another embodiment provides a display device including a polyimide or poly(imide-amide) copolymer film having improved surface properties due to reduced mura.

Yet another embodiment provides a method for fabricating a polyimide or poly(imide-amide) copolymer film that has reduced mura on its surface.

An embodiment provides a film including a polyimide or poly(imide-amide) copolymer, wherein the film has an amplitude of a surface roughness curve of less than or equal to 270 nanometers.

The amplitude of a surface roughness curve may be less than or equal to 235 nanometers.

The amplitude of a surface roughness curve may be less than or equal to 200 nanometers.

The amplitude of a surface roughness curve may be less than or equal to 160 nanometers.

A refractive index of the polyimide or poly(imide-amide) copolymer film may range from about 1.55 to about 1.75.

The polyimide or poly(imide-amide) copolymer film may include:

a polyimide including a structural unit represented by Chemical Formula 1; or

a poly(imide-amide) copolymer including a structural unit represented by Chemical Formula 1 and a structural unit represented by Chemical Formula 2:

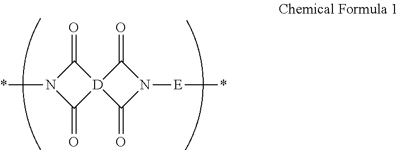

wherein in Chemical Formula 1,

D is a substituted or unsubstituted tetravalent C6 to C24 aliphatic cyclic group, a substituted or unsubstituted tetravalent C6 to C24 aromatic ring group, or a substituted or unsubstituted tetravalent C4 to C24 hetero aromatic ring group, wherein the aliphatic cyclic group, the aromatic ring group, or the hetero aromatic ring group is present as a single ring, as a condensed ring system including two or more fused rings, or as a system including two or more moieties selected from the single ring and the condensed ring system linked by a single bond, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 1≤p≤10, and 1≤q≤10), —C(CF₃)(C₆H₅)—, or —C(═O)NH—, and

E is a substituted or unsubstituted divalent C6 to C24 aliphatic cyclic group, a substituted or unsubstituted divalent C6 to C24 aromatic ring group, or a substituted or unsubstituted divalent C4 to C24 hetero aromatic ring group, wherein the aliphatic cyclic group, the aromatic ring group, or the hetero aromatic ring group is present as a single ring, as a condensed ring system including two or more fused rings, or as a system including two or more moieties selected from the single ring and the condensed ring system linked by a single bond, a fluorenylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 15≤p≤10, and 1≤q≤10), —C(CF₃)(CH₅)—, or —C(═O)NH—; Chemical Formula 2

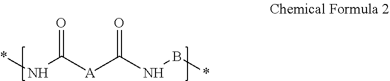

wherein in Chemical Formula 2,

A and B are each independently a substituted or unsubstituted divalent C6 to C24 aliphatic cyclic group, a substituted or unsubstituted divalent C6 to C24 aromatic ring group, or a substituted or unsubstituted divalent C4 to C24 hetero aromatic ring group, wherein the aliphatic cyclic group, the aromatic ring group, or the hetero aromatic ring group is present as a single ring, as a condensed ring system including two or more fused rings, or as a system including two or more moieties selected from the single ring and the condensed ring system linked by a single bond, a fluorenylene group, —O—, —S—, —C(═O)—, —CH(OH)—, —S(═O)₂—, —Si(CH₃)₂—, —(CH₂)ₚ— (wherein, 15≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 15≤p≤10, and 1≤q≤10), —C(CF₃)(C₆H₅)—, or —C(═O)NH—.

D in Chemical Formula 1 may be selected from chemical formulae of Group 1:

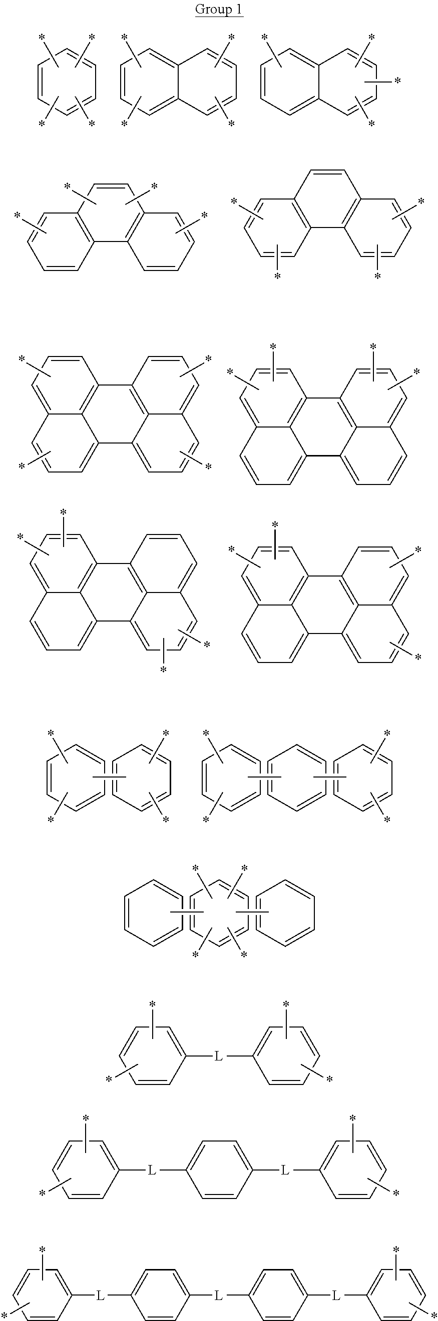

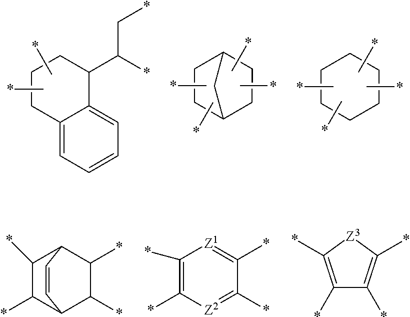

wherein, in the chemical formulae of Group 1,

each residual group may be substituted or unsubstituted, and each L may be the same or different and may be independently a single bond, —O—, —S—, —C(═O)—, —CH(OH)—, —S(═O)₂—, —Si(CH₃)₂—, —(CH₂)ₚ— (wherein, 1≤p≤10), (CF₂)_{q} (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 15≤p≤10, and 1≤q≤10), —C(CF₃)(C₆H₅)—, or —C(═O)NH—,

* is a linking point to an adjacent atom,

Z¹ and Z² are the same or different and are independently —N═ or —C(R¹⁰⁰)═, wherein R¹⁰⁰ is hydrogen or a C1 to C5 alkyl group, provided that Z¹ and Z² are not simultaneously —C(R¹⁰⁰)═, and

Z³ is —O—, —S—, or —NR¹⁰¹—, wherein R¹⁰¹ is hydrogen or a C1 to C5 alkyl group.

D in Chemical Formula 1 may be selected from chemical formulae of Group 2:

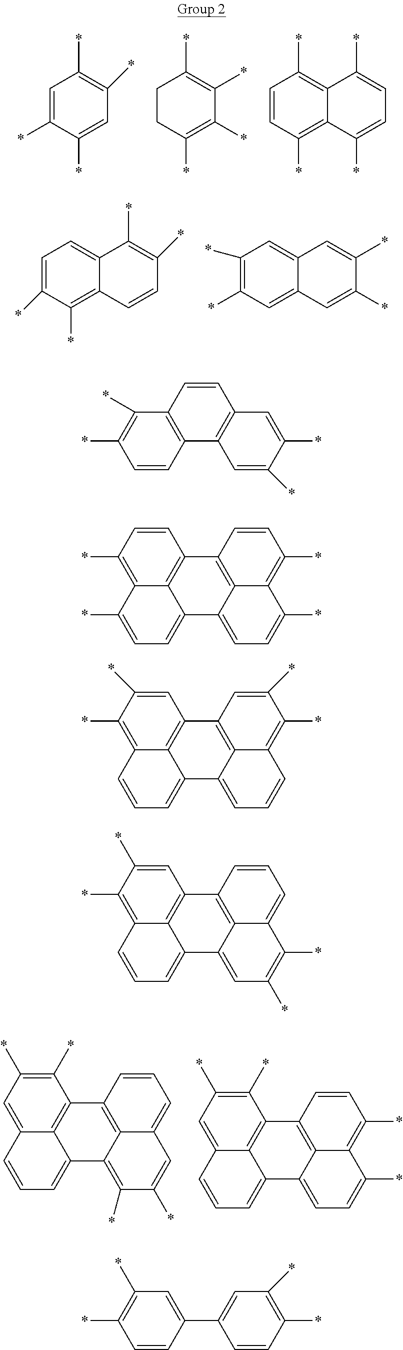

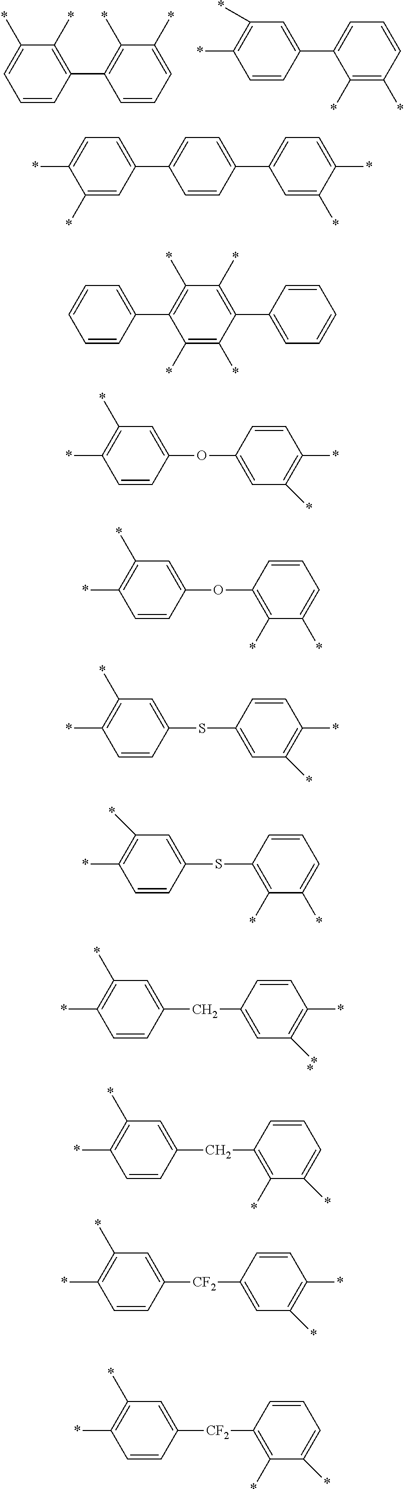

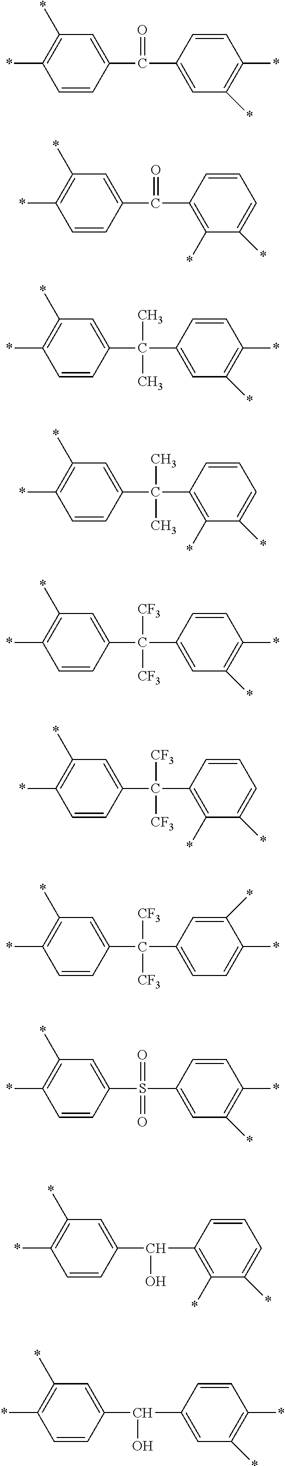

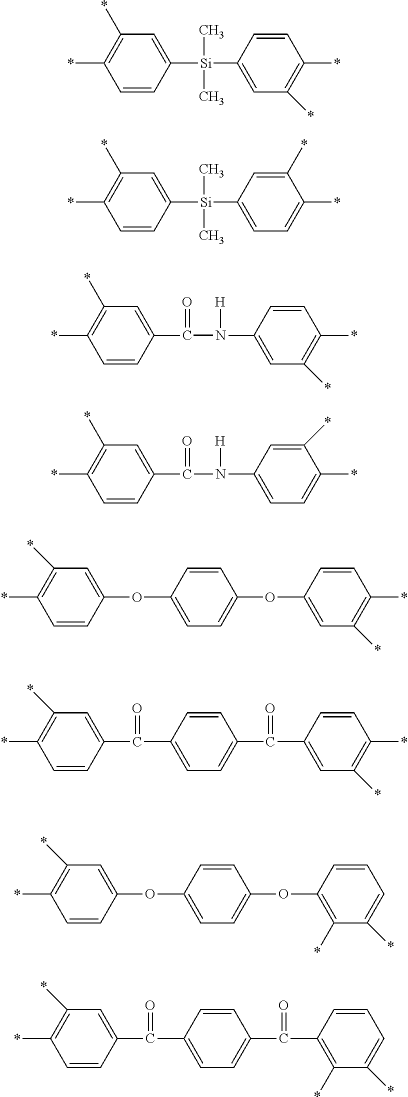

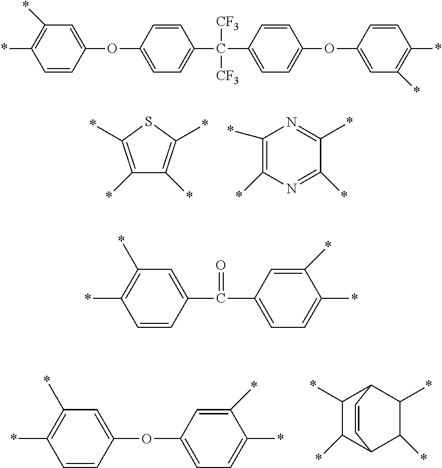

wherein, in the chemical formulae of Group 2, each residual group is substituted or unsubstituted.

E in Chemical Formula 1 and B in Chemical Formula 2 may independently be represented by Chemical Formula 5:

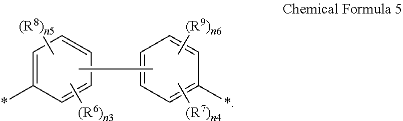

In Chemical Formula 5,

R⁶ and R⁷ are the same or different and are independently an electron withdrawing group selected from —CF₃, —CCl₃, —CBr₃, —Cl₃, —F, —Cl, —Br, —I, —NO₂, —CN, —COCH₃, and —CO₂C₂H₅,

R⁸ and R⁹ are the same or different and are independently a halogen, a hydroxy group, an alkoxy group (—OR²⁰⁴, wherein R²⁰⁴ is a C1 to C10 aliphatic organic group), a silyl group (—SiR²⁰R²⁰⁶R²⁰⁷, wherein R²⁰, R²⁰, and R²⁰⁷ are the same or different and are independently hydrogen or a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, provided that n3+n5 is an integer of 4 or less, and

n4 is an integer ranging from 1 to 4, n6 is an integer ranging from 0 to 3, provided that n4+n6 is an integer of 4 or less.

A in Chemical Formula 2 may be selected from chemical formulae of Group 3:

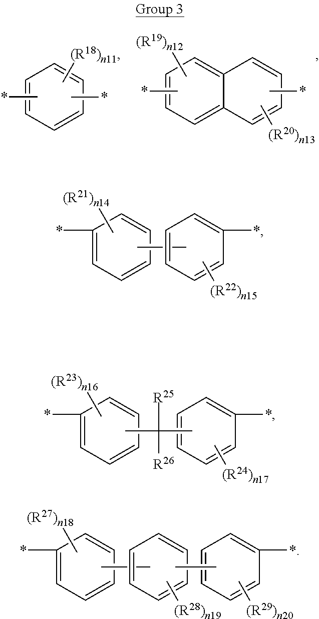

In the chemical formulae of Group 3,

R¹⁸ to R²⁹ are the same or different and are independently deuterium, a halogen, a substituted or unsubstituted C1 to C10 aliphatic organic group, or a substituted or unsubstituted C6 to C20 aromatic organic group,

n11 and n14 to n20 are independently an integer ranging from 0 to 4, and

n12 and n13 are independently an integer ranging from 0 to 3.

A in Chemical Formula 2 may be selected from chemical formulae of Group 4:

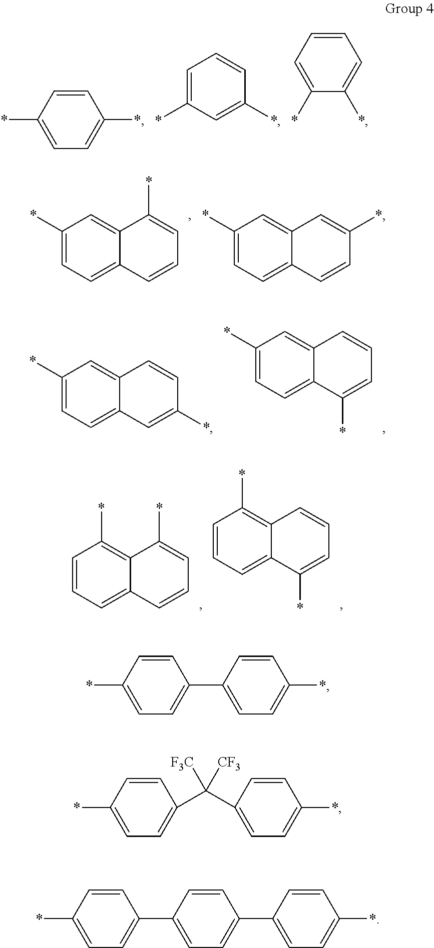

wherein, in the chemical formulae of Group 4, each residual group is substituted or unsubstituted.

The structural unit represented by Chemical Formula 1 may include at least one of a structural unit represented by Chemical Formula 9 and a structural unit represented by Chemical Formula 10:

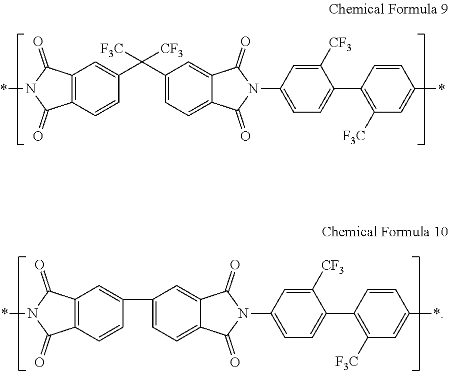

The structural unit represented by Chemical Formula 2 may include at least one of the structural units represented by Chemical Formula 6 to Chemical Formula 8:

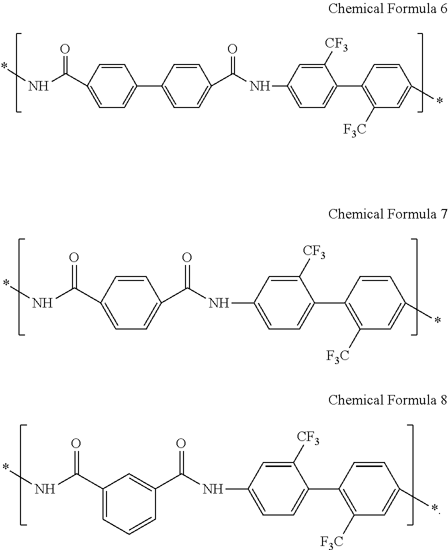

The film may include a polyimide including at least one selected from a structural unit represented by Chemical Formula 9 and a structural unit represented by Chemical Formula 10, or a poly(imide-amide) copolymer including a structural unit represented by Chemical Formula 7, and at least one selected from a structural unit represented by Chemical Formula 9 and a structural unit represented by Chemical Formula 10:

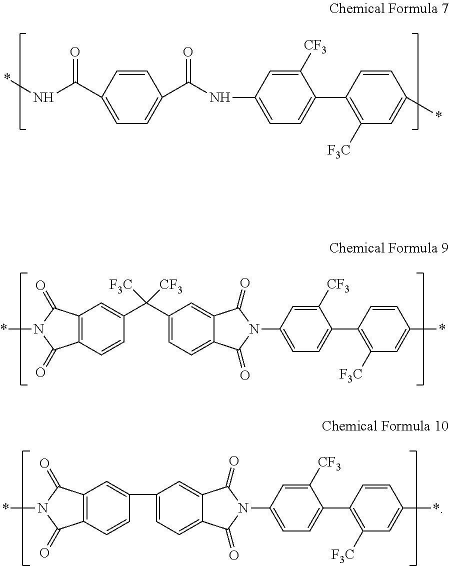

The film may include a poly(imide-amide) copolymer including the structural unit represented by Chemical Formula 7, and the at least one selected from the structural unit represented by Chemical Formula 9 and the structural unit represented by Chemical Formula 10, wherein an amount of the structural unit represented by Chemical Formula 7 may range from about 30 mole percent to about 80 mole percent, and an amount of the at least one selected from the structural unit represented by Chemical Formula 9 and the structural unit represented by Chemical Formula 10 may range from about 20 mole percent to about 70 mole percent, based on the total mole number of the structural units of the poly(imide-amide) copolymer.

Another embodiment provides a display device including the film according to an embodiment.

Yet another embodiment provides a method for fabricating a polyimide or poly(imide-amide) copolymer film by using a casting dope including a polyimide or a poly(imide-amide) copolymer, wherein the method includes:

forming a casting film by casting the casting dope on a moving supporter;

drying the casting film by treating heat and blow on the casting film; and

separating the dried film from the supporter,

wherein the drying the casting film is performed in at least three drying zones disposed in a downstream of a casting die in a direction that the supporter moves, wherein each of the at least three drying zones include a drying equipment having a plurality of nozzles extended in a direction of the width of the supporter, where each of the drying equipment supplies heat and blow to the casting film through the nozzles, wherein a temperature of the heat provided by a first drying zone disposed closest to the casting die or a second drying zone disposed next to and in a downstream of the first drying zone is the highest among the at least three drying zones.

A flux of the blow provided by the first drying zone or the second drying zone is the same as or greater than a flux of the blow provided by any of the at least three drying zones.

The supporter may be a stainless steel belt, a polyimide film, a polyethylene terephthalate film, or a hard coated film thereof.

The drying equipment included in each of the at least three drying zones is disposed above or below the supporter in the dying zones.

The temperatures of each of the at least three drying zones are each independently from about 50 degrees Celsius to about 200 degrees Celsius, and the fluxes of the blow of each of the at least three drying zones are each independently determined by controlling the plurality of nozzles from about 5 Hertz to about 60 Hertz.

### BRIEF DESCRIPTIONS OF DRAWINGS

FIG. 1 is a schematic image showing an external appearance of a surface of a large film and a method for measuring the external appearance by using stitching function of the 3 Dimensional Optical Microscopy (3D OM),

FIG. 2 is a surface roughness curve determined at the point of about 1200 micrometers in length and from 0 micrometer to about 4997 micrometers in width of the part encompassed by the broken lines in FIG. 1,

FIG. 3 is a projection image of mura of the poly(imide-amide) copolymer film prepared according to Comparative Example 1,

FIG. 4 is a projection image of mura of the poly(imide-amide) copolymer film prepared according to Comparative Example 4,

FIG. 5 is a projection image of mura of the poly(imide-amide) copolymer film prepared according to Comparative Example 5,

FIG. 6 is a projection image of mura of the poly(imide-amide) copolymer film prepared according to Example 1,

FIG. 7 is a projection image of mura of the poly(imide-amide) copolymer film prepared according to Example 3, and

FIG. 8 is a projection image of mura of the poly(imide-amide) copolymer film prepared according to Example 4.

### DETAILED DESCRIPTION

This disclosure will be described more fully hereinafter, in which embodiments are shown. This disclosure may, however, be embodied in many different forms and is not to be construed as limited to the exemplary embodiments set forth herein.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“Mixture” as used herein is inclusive of all types of combinations, including blends, alloys, solutions, and the like.

As used herein, when a specific definition is not otherwise provided, the term “substituted” refers to that at least one substituent selected from a halogen atom (F, Cl, Br, or I), a hydroxy group, a nitro group, a cyano group, an amino group (—NH₂, —NH(R¹⁰⁰) or —N(R¹⁰¹)(R¹⁰²), wherein R¹⁰⁰, R¹⁰¹, and R¹⁰² are the same or different, and are independently a C1 to C10 alkyl group), an amidino group, a hydrazine group, a hydrazone group, a carboxyl group, an ester group, a ketone group, a substituted or unsubstituted alkyl group, a substituted or unsubstituted alicyclic organic group (e.g., cycloalkyl group), a substituted or unsubstituted aryl group (e.g., benzyl group, naphthyl group, fluorenyl group, etc.), a substituted or unsubstituted alkenyl group, a substituted or unsubstituted alkynyl group, a substituted or unsubstituted heteroaryl group, and a substituted or unsubstituted heterocyclic group, or the substituents may be linked to each other to provide a ring.

As used herein, when specific definition is not otherwise provided, the term “alkyl group” refers to a C1 to C30 alkyl group, and specifically a C1 to C15 alkyl group, the term “cycloalkyl group” refers to a C3 to C30 cycloalkyl group, and specifically a C3 to C18 cycloalkyl group, the term “alkoxy group” refers to a C1 to C30 alkoxy group, and specifically a C1 to C18 alkoxy group, the term “ester group” refers to a C2 to C30 ester group, and specifically a C2 to C18 ester group, the term “ketone group” refers to a C2 to C30 ketone group, and specifically a C2 to C18 ketone group, the term “aryl group” refers to a C6 to C30 aryl group, and specifically a C6 to C18 aryl group, and the term “alkenyl group” refers to a C2 to C30 alkenyl group, and specifically a C2 to C18 alkenyl group.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C1 to C30 alkyl” refers to a C1 to C30 alkyl group substituted with C6 to C30 aryl group, the total number of carbon atoms in the resulting aryl substituted alkyl group is C7 to C60.

As used herein, the term “aliphatic cyclic group” refers to a group derived from a cycloalkane, a cycloalkene, or a cycloalkyne; the term “aromatic ring group” refers to a group derived from an arene (e.g., benzene, biphenyl, naphthalene, or the like); and the term “heteroaromatic ring group” refers to a group derived from a heteroaromatic compound comprising at least one selected from O, N, S, P, Si, or a combination thereof.

As used herein, the term “C1 to C10 aliphatic organic group” covers a C1 to C10 alkyl group, a C2 to C10 alkenyl group, a C2 to C10 alkynyl group, a C3 to C10 cycloalkyl group, C3 to C10 cycloalkenyl group, or a C3 to C10 cycloalkynyl group. As used herein, the term “C6 to C20 aromatic organic group” covers a C6 to C20 aryl group (e.g., phenyl group, a biphenyl group, a naphthyl group, or the like), and a C6 to C20 heteroaryl group (e.g., a pyridinyl group, a thiophenyl group, a pyrrolyl group, or the like).

As used herein, when specific definition is not otherwise provided, the term “combination” refers to mixing or copolymerization. Herein, “copolymerization” refers to a random copolymerization, a block copolymerization, or a graft copolymerization.

As used herein, the terms “polyimide” and “polyamic acid” may be used to have the same meanings.

In addition, in the specification, “*” may refer to a point of attachment to nitrogen, carbon, or another atom.

A polyimide or poly(imide-amide) copolymer film has high light transmittance, thermal stability, mechanical strength, flexibility, and the like, and thus, may be useful as a display substrate material. Recently, there have been attempts to use the polyimide or poly(imide-amide) copolymer film as a high hardness window film for replacing the uppermost glass disposed in a mobile device, such as a cellular phone, tablet personal computer, and the like, and thus more improved mechanical and optical properties are required.

Meanwhile, a polyimide or poly(imide-amide) copolymer film has higher refractive index than cellulose ester films, such as, for example, a cellulose triacetate film. In the case of a film having a high refractive index, there may be visual quality deterioration due to mura in the surface of the film occurred in the process of preparing the film. Specifically, while mura may not be a problem during operation of a device, it may cause image distortion in the surface of the film depending on light or angle. Therefore, when using a film having a high refractive index, such as, for example, a polyimide or poly(imide-amide) copolymer film, it may possible to improve surface properties of the film by reducing mura to improve visual quality.

In general, mura occurs in a form of lines in a Machine Direction (MD), i.e., in accordance with the direction along which a supporter on which a film is prepared runs (moves) after casting a casting dope including a polymer solution and drying the film by supplying heat and blow during a process of preparing a film. Mura may be observed by an image projected on a white screen, the image may be produced by radiating light to a sample film by a Xenon lamp in a dark room, wherein a Xenon lamp, a sample film, and a white screen are lined up in a row. Mura has a relatively long wavelength, such as, for example, a few millimeters order, and a relatively high amplitude, such as, for example, micrometers order, based on the sectional shape of the lines. Thus, it has been difficult to quantitatively determine the surface roughness of the film by using an Atomic Force Microscopy (AFM) or a Scanning Electron Microscopy (SEM), which have been usually used to determine surface roughness of a material. Accordingly, the mura has usually been determined qualitatively by using a projection image of the mura.

The inventors have quantitatively measured a wavelength and amplitude of a surface roughness curve of a large film by using the stitching function of 3 Dimensional Optical Microscopy (3D OM) as a method for quantitatively determining mura having a millimeter ordered wavelength and a micrometer ordered amplitude. Further, by analyzing the quantitative determination of mura, the inventors have found that the visual quality deterioration due to mura has no relation with the wavelength of the surface roughness curve, but depends on the amplitude of the surface roughness curve.

In particular, the “stitching function of the 3D OM” relates to attaching a large film of which the surface shape is to be determined to a surface of a glass plate via an adhesive film, such as, for example, the Pressure Sensitive Adhesive (PSA, 3M Com. Ltd.), determining the surface roughness of a small part having a predetermined size in the film by using the 3D OM, repeat the determining process for the other parts having the same size in the film, and connecting the images of the small parts to obtain a quantitative surface roughness of the whole large film. When connecting the images of the small parts to make up a whole image of the large film, about 20% of the peripheral images of each small part are overlapped with each other.

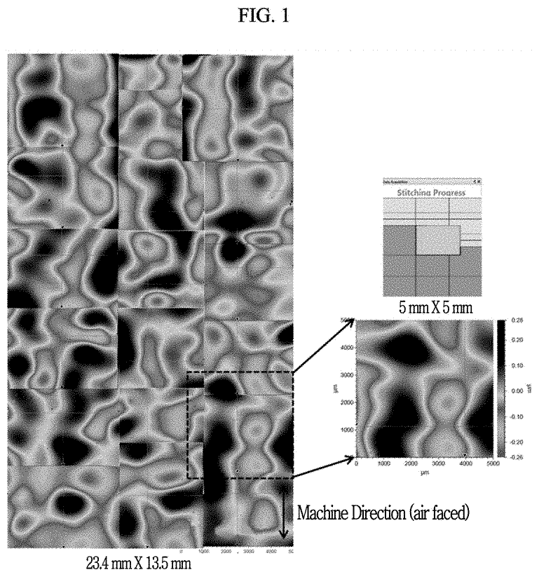

FIG. 1 annexed to this specification is an image showing a surface shape of a whole large film having a length of 23.4 millimeters (mm) and a width of 13.5 mm, which has been obtained by measuring surface roughness of 15 small parts in the film having a size of 5 millimeters by 5 millimeters (i.e., 5 mm×5 mm) by using the stitching function of the 3D OM, and connecting the images of each small part to make up an whole large of the large film. An image of a small part encompassed by broken lines in FIG. 1 has been enlarged.

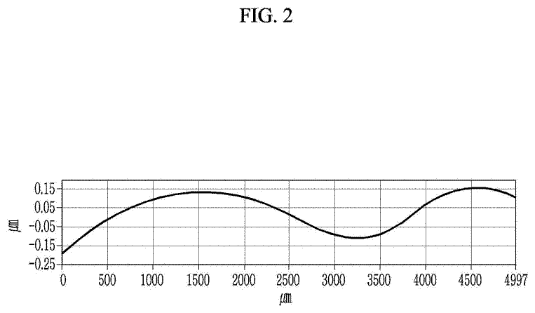

FIG. 2 is a surface roughness curve determined at the point of about 1200 micrometers in length and a width from 0 to about 4997 micrometers of the part encompassed by the broken lines in FIG. 1.

Further, it has been confirmed that the surface roughness determined by using the 3D OM corresponds to the results of mura obtained by the conventional method of projection image.

In this regard, the inventors have confirmed that the visibility and surface quality of a polyimide or poly(imide-amide) copolymer film having a relatively high refractive index can be improved by controlling the amplitude of the surface roughness curve to be in a predetermined range, and thus have completed the present inventive concept.

Accordingly, an embodiment provides a polyimide or poly(imide-amide) copolymer film having reduced mura on its surface. The amplitude of a surface roughness curve of the polyimide or poly(imide-amide) copolymer film may be less than or equal to 270 nanometers (nm), for example, less than or equal to 260 nanometers (nm), for example, less than or equal to 250 nanometers (nm), for example, less than or equal to 240 nanometers (nm), for example, less than or equal to 235 nanometers (nm), for example, less than or equal to 230 nanometers (nm), for example, less than or equal to 220 nanometers (nm), for example, less than or equal to 210 nanometers (nm), for example, less than or equal to 200 nanometers (nm), for example, less than or equal to 190 nanometers (nm), for example, less than or equal to 180 nanometers (nm), for example, less than or equal to 170 nanometers (nm), for example, less than or equal to 160 nanometers (nm), for example, less than or equal to 150 nanometers (nm), for example, less than or equal to 140 nanometers (nm), and for example, less than or equal to 130 nanometers (nm).

As described above, a film including a polyimide or poly(imide-amide) copolymer may has a relatively high refractive index, that is, from about 1.55 to about 1.75, compared with the other transparent organic polymer film.

Accordingly, it may be possible to solve the problem of surface quality deterioration due to mura of a film including a polyimide or poly(imide-amide) copolymer and having a relatively high refractive index by maintaining the amplitude of a surface roughness curve of the film in the above range.

The film including a polyimide or poly(imide-amide) copolymer may include any polyimide or poly(imide-amide) copolymer that can be used as an optical film, and may have an improved surface quality by increasing visibility by maintaining the amplitude of a surface roughness curve of the film in the above range. Accordingly, the film including a polyimide or poly(imide-amide) copolymer is not limited to a specific type. However, in an exemplary embodiment, the film including a polyimide or poly(imide-amide) copolymer may include a polyimide including a structural unit represented by Chemical Formula 1, or a poly(imide-amide) copolymer including a structural unit represented by Chemical Formula 1 and a structural unit represented by Chemical Formula 2, and has excellent optical properties, as well as good mechanical properties:

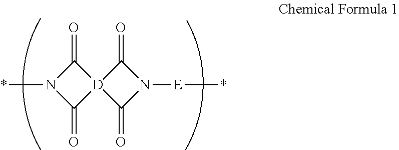

In Chemical Formula 1,

D is a substituted or unsubstituted tetravalent C6 to C24 aliphatic cyclic group, a substituted or unsubstituted tetravalent C6 to C24 aromatic ring group, or a substituted or unsubstituted tetravalent C4 to C24 hetero aromatic ring group, wherein the aliphatic cyclic group, the aromatic ring group, or the hetero aromatic ring group is present as a single ring, as a condensed ring system including two or more fused rings, or as a system including two or more moieties selected from the single ring and the condensed ring system linked by a single bond, —O—, —S—, —C(═O)—, —CH(OH)—, —S(═O)₂—, —Si(CH₃)₂—, —(CH₂)ₚ— (wherein, 15≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 1≤p≤10, and 1≤q≤10), —C(CF₃)(C₆H₅)—, or —C(═O)NH—, and

E is a substituted or unsubstituted divalent C6 to C24 aliphatic cyclic group, a substituted or unsubstituted divalent C6 to C24 aromatic ring group, or a substituted or unsubstituted divalent C4 to C24 hetero aromatic ring group, wherein the aliphatic cyclic group, the aromatic ring group, or the hetero aromatic ring group is present as a single ring, as a condensed ring system including two or more fused rings, or as a system including two or more moieties selected from the single ring and the condensed ring system linked by a single bond, a fluorenylene group, —O—, —S—, —C(═O)—, —CH(OH)—, —S(═O)₂—, —Si(CH₃)₂—, —(CH₂)ₚ— (wherein, 15≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 15≤p≤10, and 1≤q≤10), —C(CF₃)(C₆H₅)—, or —C(═O)NH—.

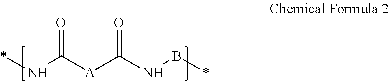

In Chemical Formula 2,

A and B are independently a substituted or unsubstituted divalent C6 to C24 aliphatic cyclic group, a substituted or unsubstituted divalent C6 to C24 aromatic ring group, or a substituted or unsubstituted divalent C4 to C24 hetero aromatic ring group, wherein the aliphatic cyclic group, the aromatic ring group, or the hetero aromatic ring group is present as a single ring, as a condensed ring system including two or more fused rings, or as a system including two or more moieties selected from the single ring and the condensed ring system linked by a single bond, a fluorenylene group, —O—, —S—, —C(═O)—, —CH(OH)—, —S(═O)₂—, —Si(CH₃)₂—, —(CH₂)ₚ— (wherein, 15≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 15≤p≤10, and 1≤q≤10), —C(CF₃)(C₆H₅)—, or —C(═O)NH—.

D in Chemical Formula 1 may be selected from the chemical formulae of Group 1:

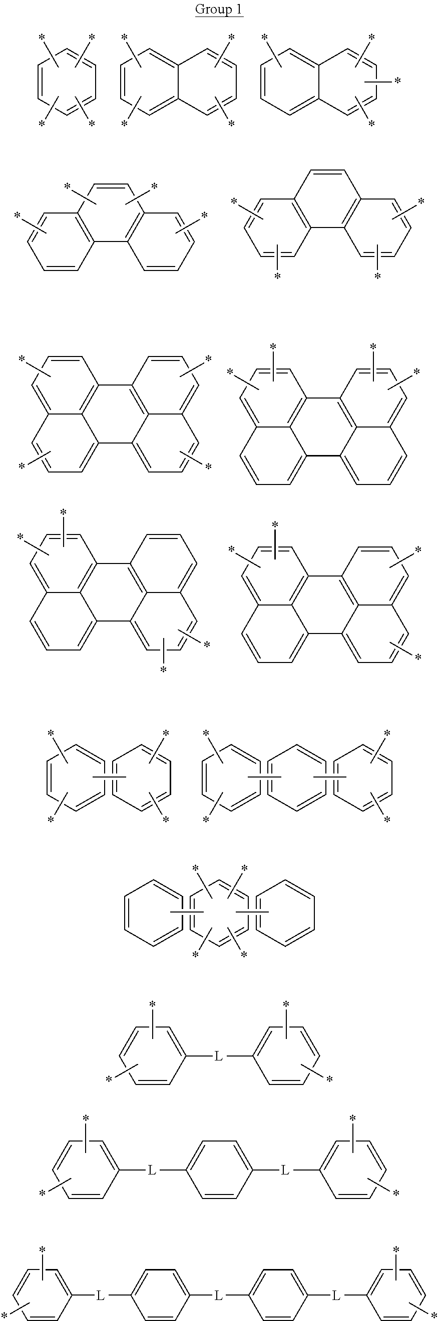

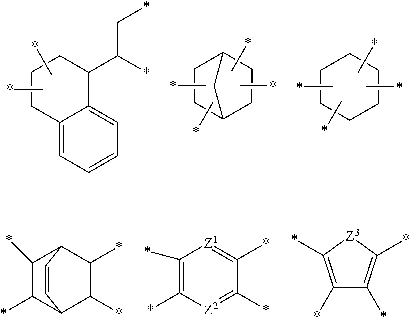

wherein, in the chemical formulae of Group 1,

each residual group may be substituted or unsubstituted, and each L may be the same or different and may be independently a single bond, —O—, —S—, —C(═O)—, —CH(OH)—, —S(═O)₂—Si(CH₃)₂—, —(CH₂)ₚ— (wherein, 15≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 15≤p≤10, and 1≤q≤10), —C(CF₃)(C₆H₅)—, or —C(═O)NH—,

* is a linking point to an adjacent atom,

Z¹ and Z² are the same or different and are independently —N═ or —C(R¹⁰⁰)═, wherein R¹⁰⁰ is hydrogen or a C1 to C5 alkyl group, provided that Z¹ and Z² are not simultaneously —C(R¹⁰⁰)═, and

Z³ is —O—, —S—, or —NR¹⁰¹—, wherein R¹⁰¹ is hydrogen or a C1 to C5 alkyl group.

The chemical formulae of Group 1 may be represented by the chemical formulae of Group 2, but are not limited thereto:

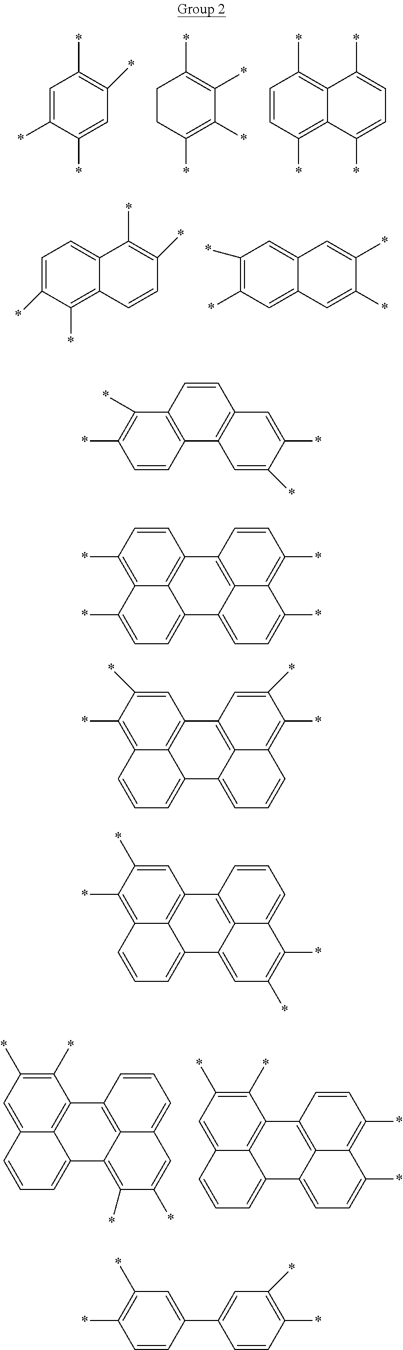

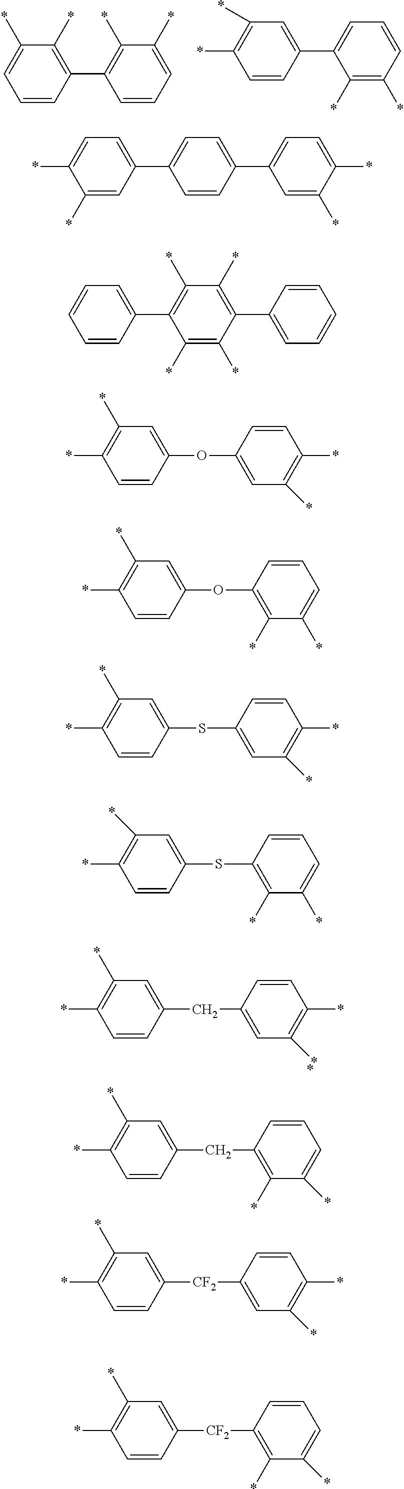

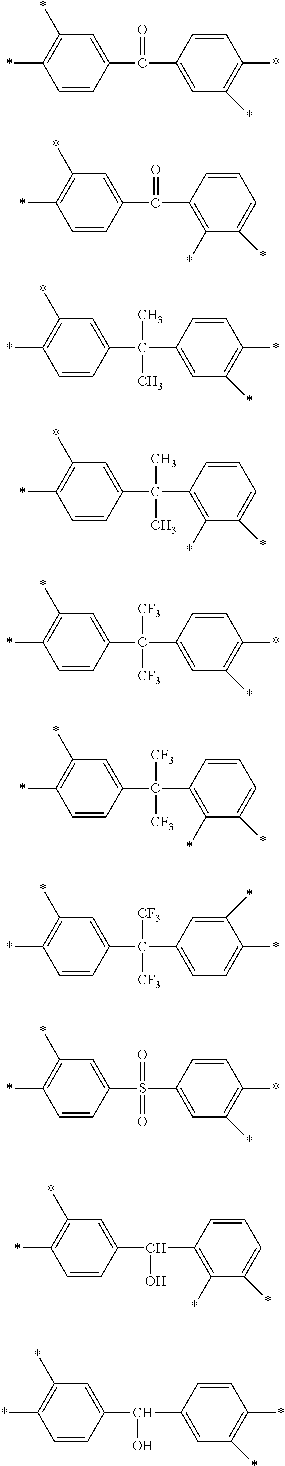

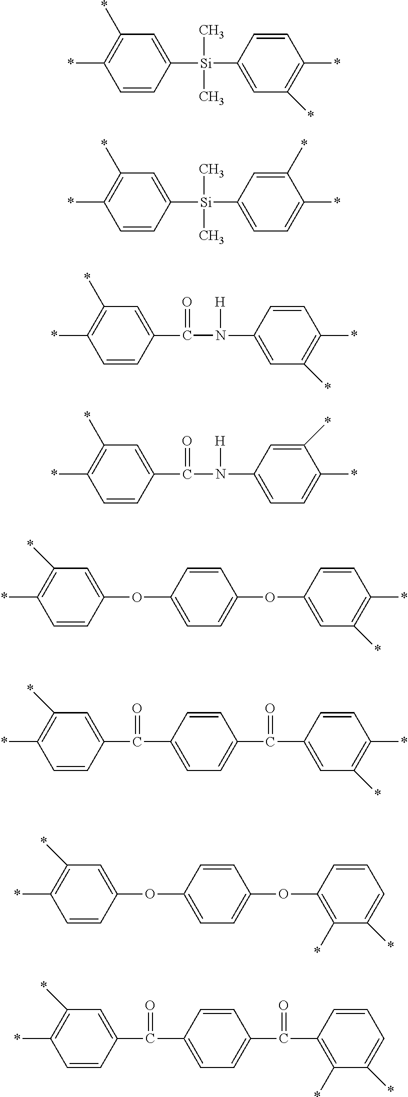

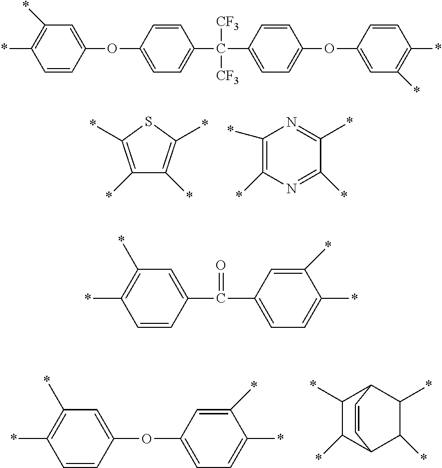

wherein, in the chemical formulae of Group 2, each residual group is substituted or unsubstituted.

E in Chemical Formula 1 and B in Chemical Formula 2 may be represented by Chemical Formula 5:

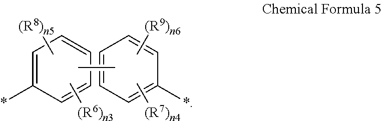

In Chemical Formula 5,

R⁶ and R⁷ are the same or different and are independently an electron withdrawing group, for example, —CF₃, —CCl₃, —CBr₃, —Cl₃, —F, —Cl, —Br, —I, —NO₂, —CN, —COCH₃, and —CO₂C₂H₅,

R⁸ and R⁹ are the same or different and are independently a halogen, a hydroxy group, an alkoxy group (—OR²⁰⁴, wherein R²⁰⁴ is a C1 to C10 aliphatic organic group), a silyl group (—SiR²⁰⁵R²⁰⁶R²⁰⁷, wherein R²⁰⁵, R²⁰⁶, and R²⁰⁷ are the same or different and are independently hydrogen or a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, provided that n3+n5 is an integer of 4 or less, and

n4 is an integer ranging from 1 to 4, n6 is an integer ranging from 0 to 3, provided that n4+n6 is an integer of 4 or less.

In an exemplary embodiment, A in Chemical Formula 2 may be selected from chemical formulae represented by Group 3:

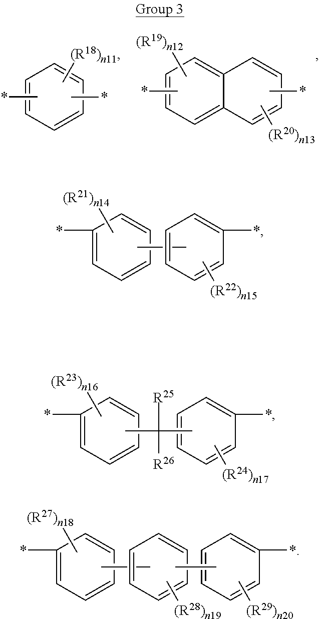

In the chemical formulae represented by Group 3,

R¹⁸ to R²⁹ are the same or different and are independently deuterium, a halogen, a substituted or unsubstituted C1 to C10 aliphatic organic group, or a substituted or unsubstituted C6 to C20 aromatic organic group,

n11 and n14 to n20 are independently an integer ranging from 0 to 4, and

n12 and n13 are independently an integer ranging from 0 to 3.

In an exemplary embodiment, the chemical formulae of Group 3 may be, for example, represented by chemical formulae of Group 4, but are not limited thereto:

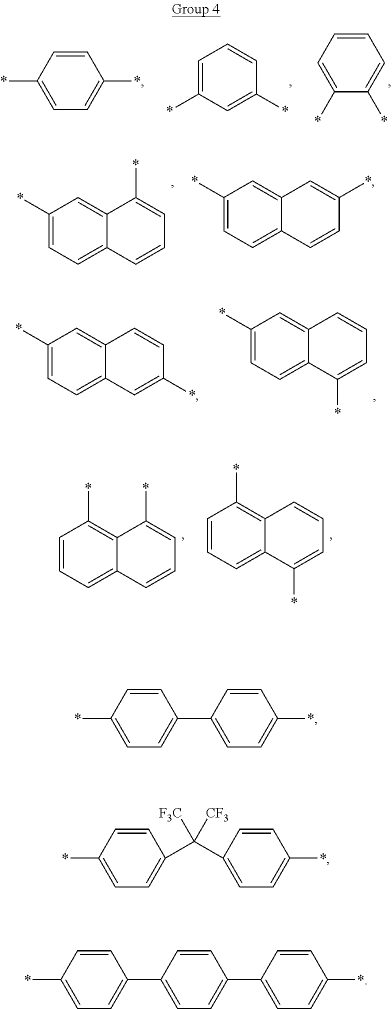

wherein, in the chemical formulae of Group 4, each residual group is substituted or unsubstituted.

In an exemplary embodiment, the structural unit represented by Chemical Formula 1 may include at least one selected from a structural unit represented by Chemical Formula 9 and a structural unit represented by Chemical Formula 10:

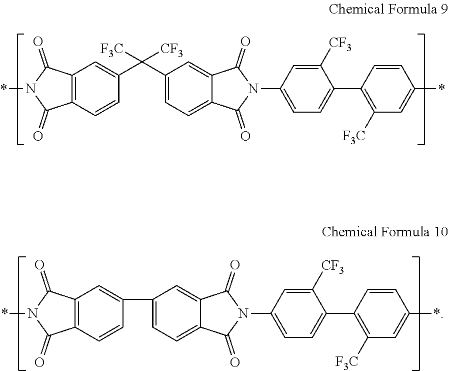

In an exemplary embodiment, the structural unit represented by Chemical Formula 2 may include at least one selected from structural units represented by Chemical Formula 6 to Chemical Formula 8:

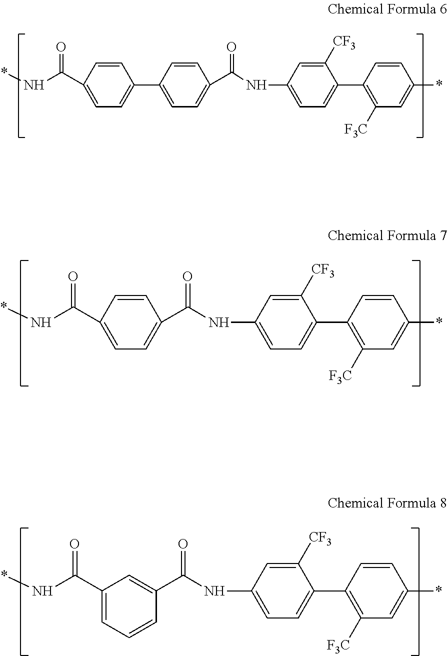

In an exemplary embodiment, the film may include a poly(imide-amide) copolymer including a structural unit represented by Chemical Formula 7, and at least one selected from a structural unit represented by Chemical Formula 9 and a structural unit represented by Chemical Formula 10:

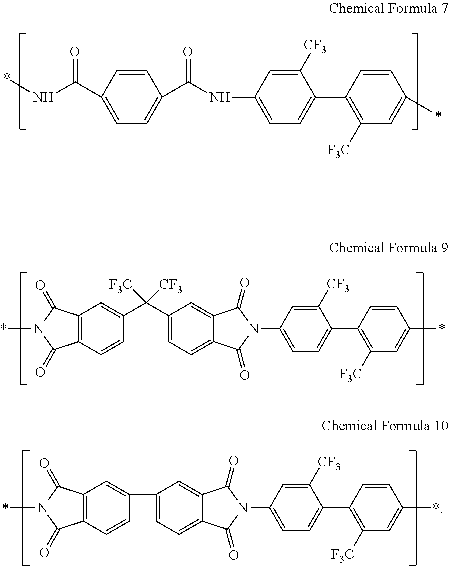

In an exemplary embodiment, the film may include a poly(imide-amide) copolymer that includes the structural unit represented by Chemical Formula 7 and the at least one selected from the structural unit represented by Chemical Formula 9 and the structural unit represented by Chemical Formula 10, wherein an amount of the structural unit represented by Chemical Formula 7 may range from about 30 mole percent (mole %) to about 80 mole %, for example, from about 35 mole % to about 80 mole %, for example, from about 40 mole % to about 80 mole %, for example, from about 45 mole % to about 80 mole %, for example, from about 50 mole % to about 80 mole %, for example, from about 55 mole % to about 80 mole %, for example, from about 60 mole % to about 80 mole %, for example, from about 65 mole % to about 80 mole %, for example, from about 65 mole % to about 75 mole %, and, for example, from about 65 mole % to about 70 mole %, based on the total mole number of the structural units of the poly(imide-amide) copolymer, and an amount of the at least one structural units represented by Chemical Formula 9 and Chemical Formula 10 may range from about 20 mole % to about 70 mole %, for example, from about 20 mole % to about 65 mole %, for example, from about 20 mole % to about 60 mole %, for example, from about 20 mole % to about 55 mole %, for example, from about 20 mole % to about 50 mole %, for example, from about 20 mole % to about 45 mole %, for example, from about 20 mole % to about 40 mole %, for example, from about 20 mole % to about 35 mole %, for example, from about 25 mole % to about 35 mole %, and, for example, from about 25 mole % to about 30 mole %, based on the total mole number of the structural units of the poly(imide-amide) copolymer.

The film including the poly(imide-amide) copolymer that includes an imide structural unit and an amide structural unit in the above mole percentage range may have good mechanical strength, such as, for example, a high tensile modulus and high surface hardness, and excellent optical properties, such as, for example, a high light transmittance, a low yellowness index (YI), a low haze, a high UV resistance property, and the like.

The polyimide or poly(imide-amide) copolymer including the above structural units may easily be prepared by a method well-known to the related art. For example, the imide structural unit may be prepared by reacting a diamine and a dianhydride in an organic solvent.

Examples of the diamine compound may include at least one selected from 2,2′-bistrifluoromethyl-4,4′-biphenyldiamine (TFDB); m-phenylene diamine; p-phenylene diamine; 1,3-bis(4-aminophenyl) propane; 2,2-bis(4-aminophenyl) propane; 4,4′-diamino-diphenyl methane; 1,2-bis(4-aminophenyl) ethane; 1,1-bis(4-aminophenyl) ethane; 2,2′-diamino-diethyl sulfide; bis(4-aminophenyl) sulfide; 2,4′-diamino-diphenyl sulfide; bis(3-aminophenyl) sulfone; bis(4-aminophenyl) sulfone; 4,4′-diamino-dibenzyl sulfoxide; bis(4-aminophenyl) ether; bis(3-aminophenyl) ether; bis(4-aminophenyl)diethyl silane; bis(4-aminophenyl) diphenyl silane; bis(4-aminophenyl) ethyl phosphine oxide; bis(4-aminophenyl) phenyl phosphine oxide; bis(4-aminophenyl)-N-phenyl amine; bis(4-aminophenyl)-N-methylamine; 1,2-diamino-naphthalene; 1,4-diamino-naphthalene; 1,5-diamino-naphthalene; 1,6-diamino-naphthalene; 1,7-diamino-naphthalene; 1,8-diamino-naphthalene; 2,3-diamino-naphthalene; 2,6-diamino-naphthalene; 1,4-diamino-2-methyl-naphthalene; 1,5-diamino-2-methyl-naphthalene; 1,3-diamino-2-phenyl-naphthalene; 4,4′-diamino-biphenyl; 3,3′-diamino-biphenyl; 3,3′-dichloro-4,4′-diamino-biphenyl; 3,3′-dimethyl-4,4′-diamino-biphenyl; 2,2′-dimethyl-4,4′-diamino-biphenyl; 3,3′-dimethoxy-4,4′-diamino-biphenyl; 4,4′-bis(4-aminophenoxy)-biphenyl; 2,4-diamino-toluene; 2,5-diamino-toluene; 2,6-diamino-toluene; 3,5-diamino-toluene; 1,3-diamino-2,5-dichloro-benzene; 1,4-diamino-2,5-dichloro-benzene; 1-methoxy-2,4-diamino-benzene; 1,4-diamino-2-methoxy-5-methyl-benzene; 1,4-diamino-2,3,5,6-tetramethyl-benzene; 1,4-bis(2-methyl-4-amino-pentyl)-benzene; 1,4-bis(1,1-dimethyl-5-amino-pentyl)-benzene; 1,4-bis(4-aminophenoxy)-benzene; o-xylylene diamine; m-xylylene diamine; p-xylylene diamine; 3,3′-diamino-benzophenone; 4,4′-diamino-benzophenone; 2,6-diamino-pyridine; 3,5-diamino-pyridine; 1,3-diamino-adamantane; bis[2-(3-aminophenyl)hexafluoroisopropyl]diphenyl ether; 3,3′-diamino-1,1′-diadamantane; N-(3-aminophenyl)-4-aminobenzamide; 4-aminophenyl-3-aminobenzoate; 2,2-bis(4-aminophenyl) hexafluoropropane; 2,2-bis(3-aminophenyl) hexafluoropropane; 2-(3-aminophenyl)-2-(4-aminophenyl)hexafluoropropane; 2,2-bis[4-(4-aminophenoxy)phenyl] hexafluoropropane; 2,2-bis[4-(2-chloro-4-aminophenoxy)phenyl hexafluoropropane; 1,1-bis(4-aminophenyl)-1-phenyl-2,2,2-trifluoroethane; 1,1-bis[4-(4-aminophenoxy)phenyl]-1-phenyl-2,2,2-trifluoroethane; 1,4-bis(3-aminophenyl) buta-1-ene-3-yne; 1,3-bis(3-aminophenyl) hexafluoropropane; 1,5-bis(3-aminophenyl) decafluoropentane; and 4,4′-bis[2-(4-aminophenoxyphenyl) hexafluoroisopropyl] diphenyl ether, diaminocyclohexane, bicyclohexyldiamine, 4,4′-diaminobicyclohexylmethane, and diaminofluorene. Such diamine compounds may be commercially available or may be obtained by a well-known method.

For example, the diamine compound may be selected from compounds of the following structures:

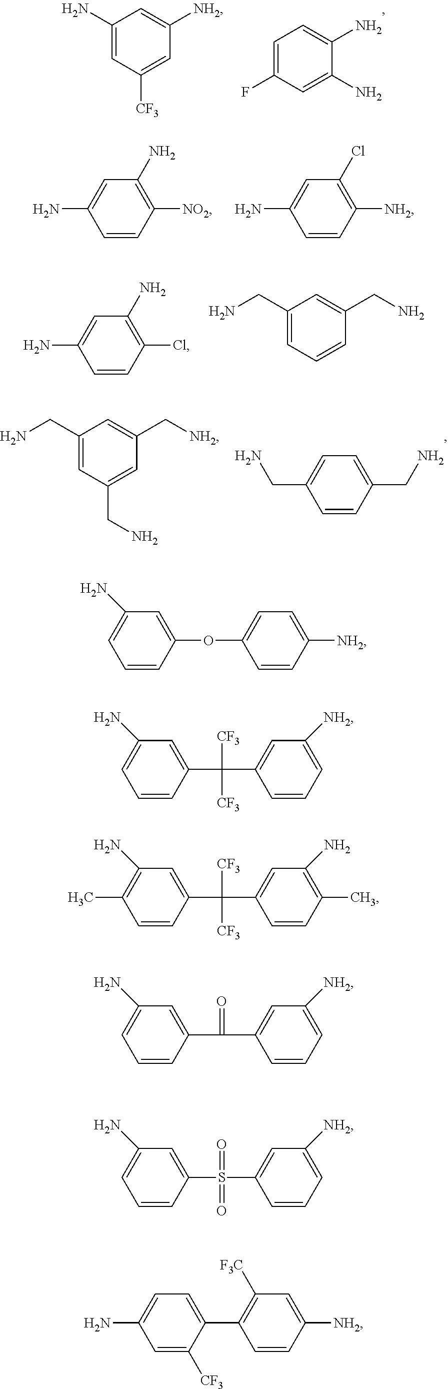

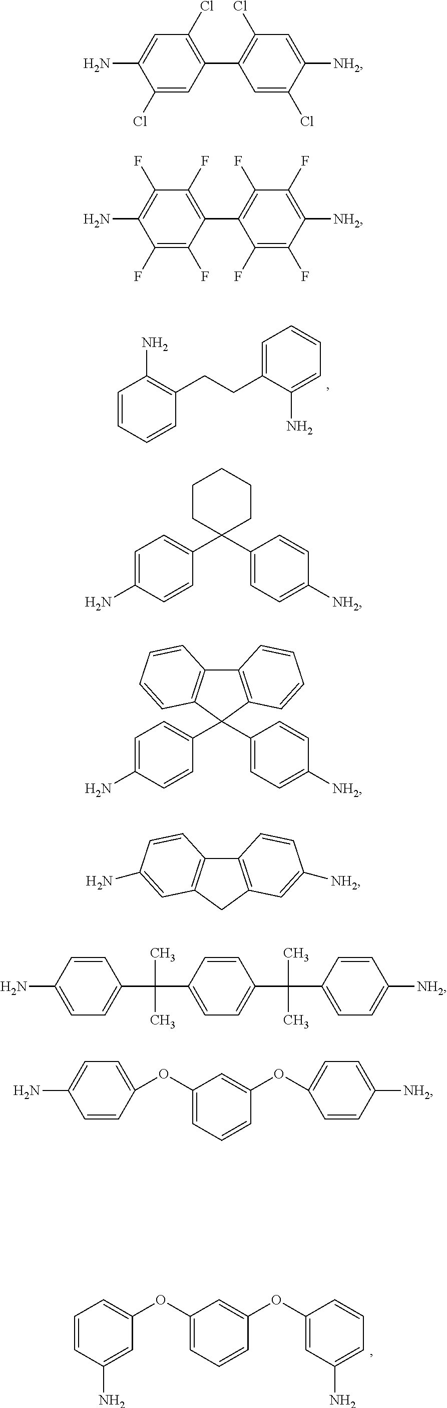

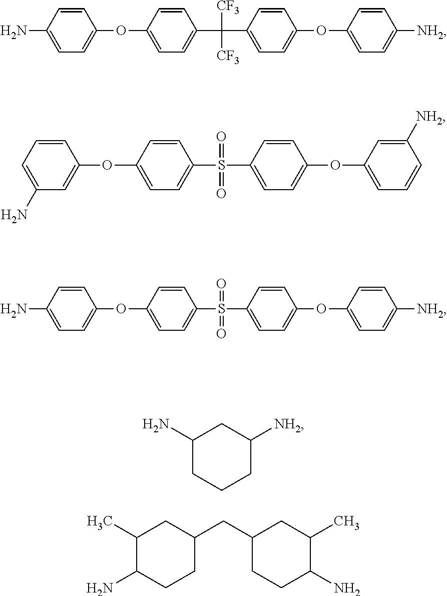

In an exemplary embodiment, the diamine may be 2,2′-bis(trifuoromethyl) benzidine (TFDB).

The dianhydride may be a tetracarboxylic dianhydride, and such a compound may be 3,3′,4,4′-biphenyl tetracarboxylic dianhydride (BPDA), bicyclo[2.2.2]oct-7-ene-2,3,5,6-tetracarboxylic dianhydride (BTDA), 3,3′,4,4′-diphenyl sulfone tetracarboxylic dianhydride (DSDA), 4,4′-(hexafluoroisopropylidene)diphthalic anhydride (6FDA), 4,4′-oxydiphthalic anhydride (ODPA), pyromellitic dianhydride (PMDA), 4-(2,5-dioxotetrahydrofuran-3-yl)-1,2,3,4-tetrahydronaphthalene-1,2-dicarboxylic anhydride (DTDA), 1,2,4,5-benzene tetracarboxylic dianhydride; 1,2,3,4-benzene tetracarboxylic dianhydride; 1,4-bis(2,3-dicarboxyphenoxy) benzene dianhydride; 1,3-bis(3,4-dicarboxyphenoxy) benzene dianhydride; 1,2,4,5-naphthalene tetracarboxylic dianhydride; 1,2,5,6-naphthalene tetracarboxylic dianhydride; 1,4,5,8-naphthalene tetracarboxylic dianhydride; 2,3,6,7-naphthalene tetracarboxylic dianhydride; 2,6-dichloronaphthalene-1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; 2,2′,3,3′-biphenyl tetracarboxylic dianhydride; 4,4′-bis(3,4-dicarboxyphenoxy)biphenyl dianhydride; bis(2,3-dicarboxylphenyl) ether dianhydride; 4,4′-bis(2,3-dicarboxyphenoxy) diphenyl ether dianhydride; 4,4′-bis(3,4-dicarboxyphenoxy) diphenyl ether dianhydride; bis(3,4-dicarboxylphenyl) sulfide dianhydride; 4,4′-bis(2,3-dicarboxyphenoxy) diphenyl sulfide dianhydride; 4,4′-bis(3,4-dicarboxyphenoxy) diphenyl sulfide dianhydride; bis(3,4-dicarboxylphenyl) sulfone dianhydride; 4,4′-bis(2,3-dicarboxyphenoxy) diphenyl sulfone dianhydride; 4,4′-bis(3,4-dicarboxylphenoxy) diphenyl sulfone dianhydride; 3,3′,4,4′-benzophenone tetracarboxylic dianhydride; 2,2′,3,3′-benzophenone tetracarboxylic dianhydride; 2,3,3′4′-benzophenone tetracarboxylic dianhydride; 4,4′-bis(3,4-dicarboxylphenoxy) benzophenone dianhydride; bis(2,3-dicarboxylphenyl) methane dianhydride; bis(3,4-dicarboxylphenyl) methane dianhydride; 1,1-bis(2,3-dicarboxylphenyl) ethane dianhydride; 1,1-bis(3,4-dicarboxylphenyl) ethane dianhydride; 1,2-bis(3,4-dicarboxylphenyl) ethane dianhydride; 2,2-bis(2,3-dicarboxylphenyl) propane dianhydride; 2,2-bis(3,4-dicarboxylphenyl) propane dianhydride; 2,2-bis[4-(2,3-dicarboxylphenoxy) phenyl] propane dianhydride; 2,2-bis[4-(3,4-dicarboxylphenoxy) phenyl] propane dianhydride; 2,2-bis[4-(2,3-dicarboxylphenoxy)-4′-(3,4-dicarboxylphenoxy) diphenyl] propane dianhydride; 2,2-bis[4-(3,4-dicarboxylphenoxy-3,5-dimethyl) phenyl] propane dianhydride; 2,3,4,5-thiophene tetracarboxylic dianhydride; 2,3,5,6-pyrazine tetracarboxylic dianhydride; 1,8,9,10-phenanthrene tetracarboxylic dianhydride; 3,4,9,10-perylene tetracarboxylic dianhydride; 1,3-bis(3,4-dicarboxylphenyl) hexafluoropropane dianhydride; 1,1-bis(3,4-dicarboxylphenyl)-1-phenyl-2,2,2-trifluoroethane dianhydride; 2,2-bis[4-(3,4-dicarboxylphenoxy) phenyl]hexafluoropropane dianhydride; 1,1-bis[4-(3,4-dicarboxylphenoxy) phenyl]-1-phenyl-2,2,2-trifluoroethane dianhydride; and 4,4′-bis[2-(3,4-dicarboxylphenyl)hexafluoroisopropyl] diphenyl ether dianhydride. Such anhydride compounds may be commercially available or may be obtained by a well-known method.

In an exemplary embodiment, the tetracarboxylic acid dianhydride may be 3,3′,4,4′-biphenyl tetracarboxylic dianhydride (BPDA), 4,4′-(hexafluoroisopropylidene) diphthalic anhydride (6FDA), or a combination thereof.

On the other hand, the well-known polyamide manufacturing method may include low temperature solution polymerization, interface polymerization, fusion polymerization, solid-phase polymerization, and the like. For example, the low temperature solution polymerization may be performed by reacting a dicarboxylic dihalide and a diamine in an aprotic polar solvent to form the amide structural unit represented by Chemical Formula 2.

The dicarboxylic dihalide may be at least one selected from terephthaloyl chloride (TPCl), isophthaloyl chloride (IPCl), biphenyl dicarbonyl chloride (BPCl), naphthalene dicarbonyl chloride, terphenyl dicarbonyl chloride, 2-fluoro-terephthaloyl chloride, and a combination thereof.

In an exemplary embodiment, the dicarboxylic dihalide may be terephthaloyl chloride (TPCI).

A diamine for forming the amide structural unit may be the same diamine compound as used for forming the imide structural unit. In other words, the amide structural unit may be formed by using at least one kind of the same or different diamine among the aforementioned diamine compounds.

In an exemplary embodiment, a diamine for forming an amide structural unit with the dicarboxylic dihalide may be 2,2′-bis(trifluoromethyl)benzidine (TFDB).

The aprotic polar solvent may be, for example, a sulfoxide based solvent such as dimethyl sulfoxide, diethyl sulfoxide and the like, a formamide based solvent such as N,N-dimethyl formamide, N,N-diethylformamide, and the like, an acetamide based solvent such as N,N-dimethyl acetamide, N,N-diethylacetamide and the like, a pyrrolidone based solvent such as N-methyl-2-pyrrolidone, N-vinyl-2-pyrrolidone and the like, a phenol based solvent such as phenol, o-, m- or p-cresol, xylenol, halogenated phenol, catechol, and the like, or hexamethylphosphoramide, y-butyrolactone, and the like. These solvents may be used alone or as a mixture. However, the examples of solvents are not limited thereto, and an aromatic hydrocarbon such as xylene and toluene may also be used.

The amide structural unit is formed by placing a diamine and a dicarboxylic dihalide in the same reactor and allowing them to react. The diamine and dianhydride for forming the imide and/or amic acid structural unit are then added thereto and reacted therewith to prepare a poly(amic acid-amide) copolymer.

Alternatively, the diamine and the dicarboxylic dihalide for forming the amide structural unit are reacted to prepare an amide oligomer having an amino group at both ends thereof, and a dianhydride is added to the resultant, which is used as a diamine monomer, to prepare a poly(amic acid-amide) copolymer. The latter method may require no precipitation process for removing HCl generated from a process of forming amide, and thus, the method may shorten a process time and increase a yield of producing a final product, the poly(amide-imide) copolymer.

The polyamic acid generated by the reaction of the dianhydride and the diamine or the poly(amic acid-amide) copolymer may be optionally partially or completely, chemically or thermally imidized to prepare a polyimide or poly(imide-amide) copolymer. A solution including the polyimide or poly(imide-amide) copolymer may be casted on a substrate by a well-known coating method, and then, dried and cured in the presence of heat or the like to manufacture an article such as a film, which is also well-known in the related art.

Meanwhile, as described above, when fabricating a polyimide or poly(imide-amide) copolymer film by casting a polyimide- or poly(imide-amide) copolymer-containing solution on a supporter that runs and by providing heat and blow, a weak blow is firstly applied to the film having a lot of solvent after the casting the solution to remove the solvent, and then the flux of blow and temperature are increased to cure the film, in a conventional method.

However, as shown from the Examples and Comparative Examples described in the specification, a method for preparing a film by applying a higher temperature and a greater flux of blow to the initial stage of drying right after casting a film, and then applying a lowered temperature and/or a reduced flux of blow to the film may be more efficient to reduce mura of the produced film than the conventional method including firstly applying a weak blow and a lowered temperature to a film at a first stage, and then increasing the temperature and flux of blow at a later stage as in the conventional method. In an exemplary embodiment, a greater flux of blow may be provided to the initial stage of drying right after casting a film.

Accordingly, another embodiment provides a method for fabricating a film including a polyimide or poly(imide-amide) copolymer from a casting dope including a polyimide or poly(imide-amide) copolymer, which includes:

forming a casting film by casting the casting dope on a supporter that runs (a moving supporter);

drying the casting film by treating heat and blow on the casting film; and

separating the dried film from the supporter,

wherein the drying the casting film is performed in at least three drying zones disposed in a downstream of a casting die in a direction that the supporter runs, wherein each of the at least three drying zones include a drying equipment having nozzles extended in a direction of width of the supporter, where each of the drying equipment supplies heat and blow to the casting film through the nozzles, wherein a temperature of the heat provided by a first drying zone disposed closest to the casting die or a second drying zone disposed next to and in a downstream of the first drying zone is the highest among the at least three drying zones.

In an exemplary embodiment, a flux of the blow provided by the first drying zone or the second drying zone may be the same as or greater than a flux of the blow provided by any other of the at least three drying zones.

In an exemplary embodiment, the flux of blow provided by the first or second drying zone that provides heat of the highest temperature may be the same as or greater than that provided by the other drying zone. For example, the flux of blow provided by the first or second drying zone that provides heat of the highest temperature may be greater than that provided by the other drying zone.

In an exemplary embodiment, the supporter may be a stainless steel belt, a polyimide film, a polyethylene terephthalate (PET) film, or a hard coated film thereof. When using a polyimide film, a polyethylene terephthalate (PET) film, or a hard coated film thereof as a supporter, processing cost may be reduced by not requiring complex equipment. There is no specific limit to the type of the polyimide film used as a supporter, and any polyimide films in the market may be used. Any polyimide film having high thermal resistance, durability, mechanical strength, and the like, may be suitable for repeated use and high temperature of heat and blow.

In an exemplary embodiment, the drying equipment included in each of the at least three drying zones is disposed above or below the supporter in the drying zones.

In an exemplary embodiment, the drying equipment included in each of the at least three drying zones may be disposed above and below the supporter in the drying zones in turns. For example, the drying equipment included in the first drying zone may be disposed above the supporter, the drying equipment included in the second drying zone may be disposed below the supporter, and the drying equipment included in the third drying zone may be disposed above the supporter. By allocating the drying equipment above and below the supporter in turns, the drying the casting film may be more efficiently performed, while facilitating controlling the drying temperature and flux of blow.

Meanwhile, the temperature of each of the at least three drying zones may be independently from about 50 degrees Celsius to about 200 degrees Celsius, for example, from about 50 degrees Celsius to about 180 degrees Celsius, for example, from about 50 degrees Celsius to about 170 degrees Celsius, for example, from about 55 degrees Celsius to about 160 degrees Celsius, for example, from about 55 degrees Celsius to about 150 degrees Celsius, and, for example, from about 60 degrees Celsius to about 140 degrees Celsius, and are not limited thereto.

In the above range of temperatures, the temperature in at least one of the first and second drying zones may be higher than in the other drying zones. In an exemplary embodiment, the temperature in the first drying zone may be the highest, the temperature in the second drying zone may be the highest, or the temperature in the first and the second drying zones may be the same as each other and may be higher than in the other drying zones.

Further, the flux of blow of each of the at least three drying zones may be independently determined by controlling the plurality of nozzles from about 5 Hertz to about 60 Hertz.

In the above range of flux of blow, the flux of blow in at least one of the first and second drying zones may be greater than or equal to that of the other drying zones.

The at least three drying zones may include, for example, at least four drying zones, for example, at least five drying zones, for example, at least six drying zones, and, for example, at least seven drying zones.

In an exemplary embodiment, each of the at least three drying zones may include at least one drying equipment. For example, each of the at least three drying zones may independently include at least two drying equipment. For example, each of the at least three drying zones may independently include at least three drying equipment.

When at least two drying equipment are included in each of the at least three drying zones, the at least two drying equipment may independently be disposed above and/or below the supporter in each of the at least three drying zones. Alternatively, when at least two drying equipment are included in each of the at least three drying zones, all the at least two drying equipment may be disposed in the same position, that is, all the at least two drying equipment may be disposed above or below the supporter in one drying zone. In this case, the at least three drying zones may be disposed such that a first drying zone having at least two drying equipment disposed above the supporter may be firstly disposed in a downstream of the casting die, a second drying zone having at least two drying equipment disposed below the supporter may be disposed next to the first drying zone, a third drying zone having at least two drying equipment disposed above the supporter may be disposed next to the second drying zone, and the like. That is, the at least three drying zones having at least two drying equipment disposed in the same position may alternatively be disposed to place the at least two drying equipment in one drying zone above and below the supporter alternately.

The detention time of the casting film in each drying zone may range from about 30 seconds to about 5 minutes. However, the detention time may be appropriately changed by a person skilled in the art, upon considering length of the drying zone, required properties of the film to be produced, and the like.

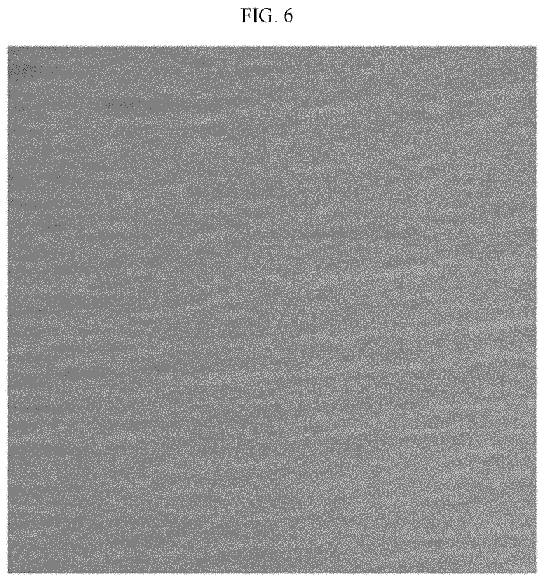

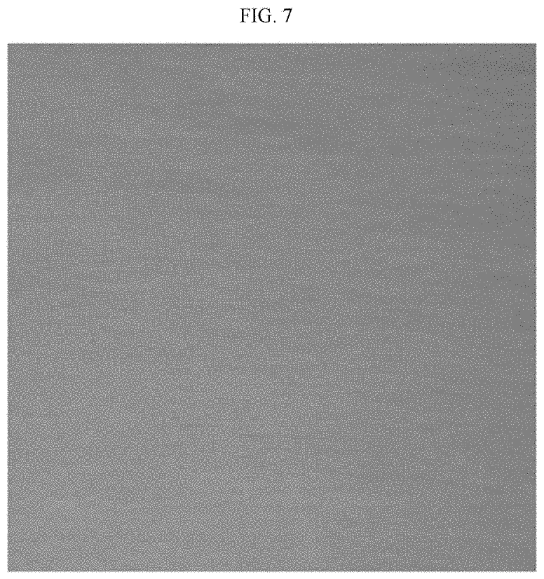

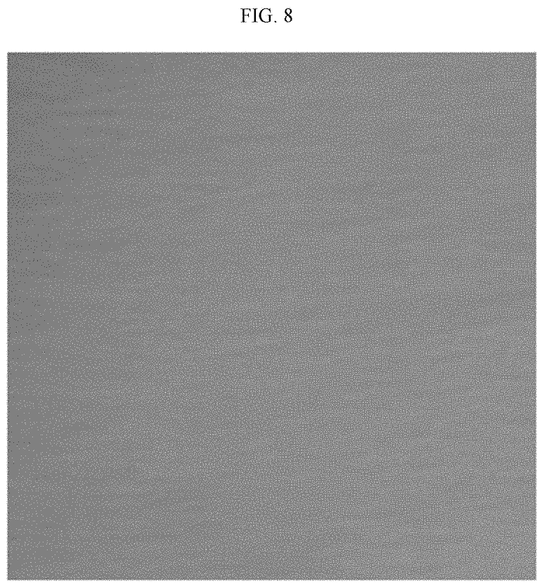

The polyimide or poly(imide-amide) copolymer film prepared by the method of an embodiment has reduced mura. For example, as described in the Examples, the polyimide or poly(imide-amide) copolymer film prepared by the method of an embodiment has an amplitude of the surface roughness curve of less than or equal to about 270 nm. A film having an amplitude of surface roughness curve in the above range has improved surface quality due to the reduced mura on the surface thereof, as shown in FIGS. 6 to 8.

Hereafter, this disclosure is described in detail with reference to examples. The following examples and comparative examples are not restrictive, but are illustrative.

### EXAMPLES

### Synthesis Example 1: Preparation of Poly(imide-amide) Copolymer Solution

63 kilograms (kg) of dimethyl acetamide is placed in a reactor, and 907 grams (g) of pyridine is added thereto under a nitrogen atmosphere. Next, 3,671 g of 2,2′-bis(trifluoromethyl)-4,4′-biphenyldiamine (TFDB) is placed in the reactor and dissolved to prepare a TFDB solution. Subsequently, 1,164 g of terephthaloyl chloride (TPCL) is added to the TFDB solution, and the mixture is stirred at 30° C. for 3 hours to obtain an amide oligomer solution. The obtained solution is treated with water to obtain a precipitate, and the precipitate is dried at 80° C. for 48 hours to obtain amide oligomer powder. 4,500 g of the amide oligomer powder, 1,375 g of 4,4′-hexafluoroisopropylidene diphthalic anhydride (6FDA), and 775 g of 3,3′,4,4′-biphenyltetracarboxylic dianhydride (BPDA) are added to 37.6 kg of dimethyl acetamide, and the mixture is allowed to react at 30° C. for 48 hours to obtain a poly(amic acid-amide) copolymer solution.

Then, 1,173 g of acetic anhydride as a chemical imidization catalyst is added to the poly(amic acid-amide) solution, and the mixture is stirred for 30 minutes. 1,374 g of pyridine is added thereto, and the obtained mixture is stirred at 30° C. for 24 hours, to prepare a poly(imide-amide) copolymer solution.

### Examples 1 to 4 and Comparative Examples 1 to 5: Preparation of Poly(Imide-Amide) Copolymer Film

Poly(imide-amide) copolymer films are fabricated from the poly(imide-amide) copolymer solution prepared in Synthesis Example 1.

Particularly, the poly(imide-amide) copolymer solution prepared in Synthesis Example 1 is casted on polyimide film a supporter to prepare a casting film, the casting film is dried after passing through five drying zones, and then the dried film is separated from the supporter. In this case, the five drying zones are referred to as from “a first zone” to “a fifth zone”, respectively, in the order from the closest to the farthest place from the casting die on which the poly(imide-amide) copolymer solution is casted. Each of the five drying zones have a drying equipment having a plurality of nozzles, and the drying equipment disposed in each drying zones are alternately disposed in the above and below the supporter. The films according to Examples 1 to 4 and Comparative Examples 1 to 5 are fabricated by changing the temperatures and flux of blow in the first to fifth zones. The temperatures and flux of blow in the first to fifth zones are described in Table 1 below. Time from the casting the solution to the separating a film is adjusted to about 15 minutes.

Then, in order to evaluate external appearance of the films, the dry films are introduced into a convection oven, where a post heat treatment is applied to the film from the room temperature to 250° C. at a heating rate of 3° C./minute. Then, evaluation for each film is performed.

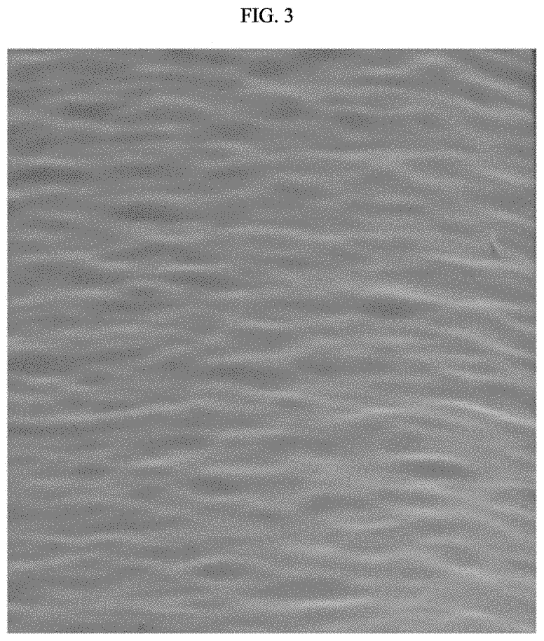

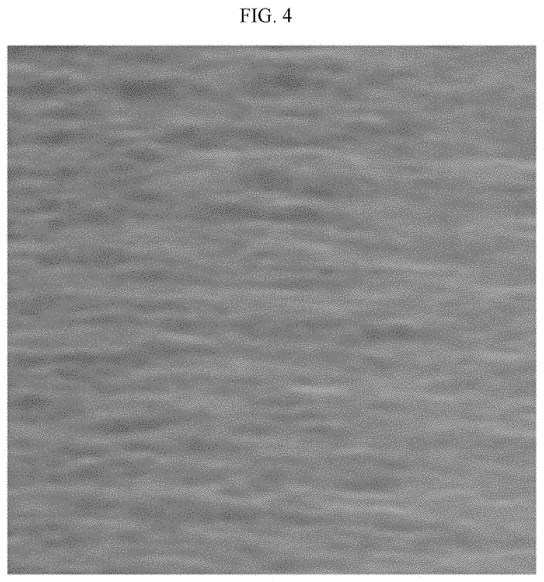

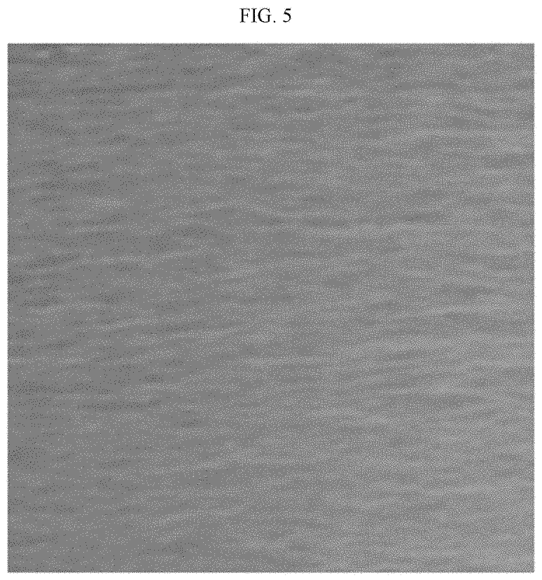

Evaluation includes qualitative analysis for external appearance of the films, and quantitative analysis determining depth of the mura of a film, i.e., amplitude of the surface roughness curve, by using 3D OM. The results are described in Table 1 below. Further, the projection images of the mura of the films prepared according to Comparative Examples 1, 4, and 5 are shown in FIGS. 3 to 5, respectively, and, the projection images of the mura of the films prepared according to Examples 1, 3, and 4 are shown in FIGS. 6 to 8, respectively.

Methods of analysis for external appearance of the films and determination by using the 3D OM are as below.

(1) Qualitative Analysis for External Appearance of a Film

A Xenon lamp (35 W, 3400 lumen (lm)), a sample film, and a white screen are lined up in a row in a dark room. Xenon lamp is lighted up and the image projected from the sample film and appearing on the white screen disposed on the back side of the sample film is observed.

In Table 1 below, “X” indicates that mura strongly appears, “Δ” indicates that mura weakly appears, “◯” indicates that mura very weakly appears, and “⊚” indicates that mura rarely appears.

(2) 3D OM Analysis

A press sensitive adhesive (PSA) film is layered on a glass plate, and a sample film is attached thereto. The sample is placed on a stage and is observed by using the 3D optical microscopy (White light interferometer, Bruker).

Then, the maximum amplitude of the film in the area of 5 mm×5 mm (mm=millimeter) is determined by using the stitching function of the 3D OM program. By repeating the determination for adjacent 14 areas, the maximum amplitudes in each area are measured, and the average of the amplitudes are described in Table 1 below.

TABLE 1

| | Temperature of each zone (° C.) | | | | | Flux of blow of each zone (Hz) | | | | | | |
|---|---|---|---|---|---|---|---|---|---|---|---|---|
| | 1^{st} | 2^{nd} | 3^{rd} | 4^{th} | 5^{th} | 1^{st} | 2^{nd} | 3^{rd} | 4^{th} | 5^{th} | Amplitude | External |
| | zone | zone | zone | zone | zone | zone | zone | zone | zone | zone | (nm) | Appearance |
| Comparative | 100 | 100 | 120 | 120 | 140 | 10 | 10 | 10 | 10 | 30 | 379 | X |
| Example 1 | | | | | | | | | | | | |
| Comparative | 100 | 100 | 120 | 120 | 140 | 35 | 35 | 35 | 35 | 30 | 379 | X |
| Example 2 | | | | | | | | | | | | |
| Comparative | 100 | 100 | 120 | 120 | 140 | 10 | 30 | 30 | 60 | 30 | 368 | X |
| Example 3 | | | | | | | | | | | | |
| Comparative | 100 | 100 | 100 | 100 | 100 | 30 | 30 | 30 | 30 | 30 | 354 | X |
| Example 4 | | | | | | | | | | | | |
| Comparative | 60 | 60 | 60 | 80 | 80 | 60 | 60 | 60 | 60 | 60 | 298 | Δ |
| Example 5 | | | | | | | | | | | | |
| Example 1 | 100 | 100 | 80 | 80 | 70 | 60 | 60 | 60 | 60 | 60 | 232 | O |
| Example 2 | 100 | 120 | 100 | 80 | 70 | 10 | 60 | 60 | 60 | 60 | 161 | ⊚ |
| Example 3 | 80 | 120 | 100 | 80 | 70 | 60 | 60 | 60 | 60 | 60 | 158 | ⊚ |
| Example 4 | 80 | 120 | 100 | 80 | 70 | 10 | 60 | 60 | 60 | 60 | 142 | ⊚ |

In Table 1 above, the unit of the flux of blow is described as “Hz (Hertz)”, as the flux of blow is adjusted by controlling the nozzles from which the blow is provided. That is, the unit for controlling the nozzles is “Hertz”. In this case, the unit of the flux of blow can be converted to “meter per second (m/s)”, and the values of the flux of blow in Table 1 can be converted to those having the unit “m/s” and described in Table 2 below.

| | | | | |
|---|---|---|---|---|
| Hertz | 10 | 30 | 35 | 60 |
| meter/second | 0.7 | 2.9 | 3.5 | 6.3 |

As shown in Tables 1 and 2, and FIGS. 3 to 8, in fabricating a film by casting a poly(imide-amide) copolymer solution on a supporter that runs (a moving supporter), all the films according to Examples 1 to 4, where the temperature in the first zone and/or in the second zone is the highest among the five zones and the flux of blow from at least one of the first and second zones is the same as or greater than any from the other zones, have amplitudes of mura of less than 270 nm determined by using the 3D OM, and exhibit good external appearance determined by the qualitative analysis of the projection images of the mura.

On the contrary, the films according to Comparative Examples 1 to 5, where any of the first zone and the second zone does not have the highest temperature among the five zones, have amplitudes of mura of greater than 270 nm determined by using the 3D OM, and exhibit bad visibility determined by the qualitative analysis of the projection images of the mura as they have a lot of fringes.

Accordingly, it is confirmed that when fabricating a poly(imide-amide) copolymer film by passing through at least three drying zones, films may have drastically improved external appearance due to reduced amplitude of surface roughness curve by supplying higher temperature of heat and stronger blow to the casting film in the drying zones disposed in the initial stage than in the later stage.

While this disclosure has been described in connection with what is presently considered to be practical exemplary embodiments, it is to be understood that the present description is not limited to the disclosed embodiments, but, on the contrary, is intended to cover various modifications and equivalent arrangements included within the spirit and scope of the appended claims.

1.-40. (canceled)

41. A method for fabricating a film comprising a polyimide or poly(imide-amide) copolymer, the method comprising:
casting a casting dope comprising a polyimide or a poly(imide-amide) copolymer on a supporter to form a casted film; and
drying the casted film by providing heat to the casted film,
wherein the providing heat to the casted film is performed in at least two steps, wherein a mean temperature of the heat provided in a prior step of the at least two steps is higher than a mean temperature of the heat provided in a later step of the at least two steps.

42. The method according to claim 41, wherein the providing heat to the casted film in the at least two steps comprises providing blow to the casted film in at least one step of the at least two steps.

43. The method according to claim 42, wherein the providing blow to the casted film is performed in the at least two steps, and wherein a mean flux of the blow in the prior step of the at least two steps is the same as or smaller than a mean flux of the blow in the later step of the at least two steps.

44. The method according to claim 41, wherein the providing heat to the casted film in the at least two steps is performed in at least three steps, wherein a mean temperature of the heat provided in a second step of the at least three steps is the same as or higher than a temperature in the other step of the at least three steps.

45. The method according to claim 41, wherein the providing heat to the casted film in the at least two steps is performed in at least three steps, wherein a mean temperature of the heat provided in a last step of the at least three steps is the same as or lower than a mean temperature in the other step of the at least three steps.

46. The method according to claim 41, wherein the providing heat to the film in the at least two steps is performed in at least two drying zones, each of which is sequentially disposed in a downstream of the supporter.

47. The method according to claim 46, wherein a mean temperature in the drying zone disposed closer to the supporter is higher than that in the drying zone disposed farther to the supporter.

48. The method according to claim 46, wherein a blow is provided in the at least two drying zones, wherein a flux of the blow in the drying zone disposed closest to the supporter is the same as or lower than the other drying zone in the at least two drying zones.

49. The method according to claim 41, wherein a mean temperature of the heat provided in the prior step of the at least two steps is greater than or equal to 100 degrees Celsius.

50. The method according to claim 43, wherein a mean flux of the blow in the prior step of the at least two steps is the same as or greater than 35 Hertz.

51. The method according to claim 43, wherein a mean flux of the blow in the later step of the at least two steps is the same as or less than 60 Hertz.

52. The method according to claim 41, further comprising separating the casted film from the supporter.

53. The method according to claim 46, wherein each of the drying zones comprises drying equipment having a plurality of nozzles through which heat is provided.

54. The method according to claim 53, wherein blow is also provided through the plurality of nozzles of the drying equipment.

55. The method according to claim 53, wherein the drying equipment is disposed above or below the casted film as the casted film passes through each of the drying zone.

56. The method according to claim 41, wherein the supporter is a stainless steel belt, a polyimide film, a polyethylene terephthalate film, or a hard coated film thereof.

57. A film comprising a polyimide or poly(imide-amide) copolymer prepared from the method according to claim 41, wherein the film has mura in a form of lines on a surface thereof and has an average amplitude of a surface roughness curve of less than or equal to 270 nanometers, wherein the surface roughness curve has a millimeter ordered wavelength and a micrometer ordered amplitude based on the sectional shape of the lines and is determined by the stitching function of the 3-Dimensional Optical Microscopy.

58. The film according to claim 57, wherein the polyimide or poly(imide-amide) copolymer comprises:
a polyimide comprising a structural unit represented by Chemical Formula 1; or
a poly(imide-amide) copolymer comprising a structural unit represented by Chemical Formula 1 and a structural unit represented by Chemical Formula 2: 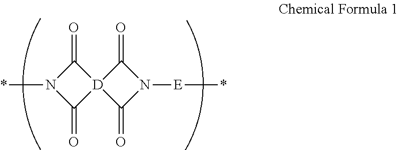
wherein in Chemical Formula 1,
D is a substituted or unsubstituted tetravalent C6 to C24 aliphatic cyclic group, a substituted or unsubstituted tetravalent C6 to C24 aromatic ring group, or a substituted or unsubstituted tetravalent C4 to C24 hetero aromatic ring group, wherein the aliphatic cyclic group, the aromatic ring group, or the hetero aromatic ring group is present as a single ring, as a condensed ring system comprising two or more fused rings, or as a system comprising two or more moieties selected from the single ring and the condensed ring system linked by a single bond, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 1≤p≤10, and 1≤q≤10), —C(CF₃)(C₆H₅)—, or —C(═O)NH—, and
E is a substituted or unsubstituted divalent C6 to C24 aliphatic cyclic group, a substituted or unsubstituted divalent C6 to C24 aromatic ring group, or a substituted or unsubstituted divalent C4 to C24 hetero aromatic ring group, wherein the aliphatic cyclic group, the aromatic ring group, or the hetero aromatic ring group is present as a single ring, as a condensed ring system comprising two or more fused rings, or as a system comprising two or more moieties selected from the single ring and the condensed ring system linked by a single bond, a fluorenylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 1≤p≤10, and 1≤q≤10), —C(CF₃)(C₆H₅)—, or —C(═O)NH—; 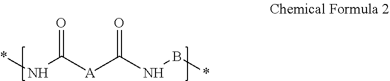
wherein in Chemical Formula 2,
A and B are each independently a substituted or unsubstituted divalent C6 to C24 aliphatic cyclic group, a substituted or unsubstituted divalent C6 to C24 aromatic ring group, or a substituted or unsubstituted divalent C4 to C24 hetero aromatic ring group, wherein the aliphatic cyclic group, the aromatic ring group, or the hetero aromatic ring group is present as a single ring, as a condensed ring system comprising two or more fused rings, or as a system comprising two or more moieties selected from the single ring and the condensed ring system linked by a single bond, a fluorenylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₂ₙ₊₁)₂—, —C(CₙF₂ₙ₊₁)₂—, —(CH₂)ₚ—C(CₙH₂ₙ₊₁)₂—(CH₂)_{q}—, or —(CH₂)ₚ—C(CₙF₂ₙ₊₁)₂—(CH₂)_{q}— (wherein, 1≤n≤10, 1≤p≤10, and 1≤q≤10), —C(CF₃)(C₆H₅)—, or —C(═O)NH—.

59. A display device comprising the film according to claim 57.
